(19) United States
(12) Patent Application Publication
(10) Pub. No.: US 2024/0208591 A1
(43) Pub. Date: Jun. 27, 2024

(54) ADJUSTABLE CARGO AREA PARTITION FOR VEHICLE

(71) Applicant: Honda Motor Co., Ltd., Tokyo (JP)

(72) Inventors: Ricky Jukuei Hsu, Rancho Palos Verdes, CA (US); Chris Jaeyoung Lah, Irvine, CA (US); Romain Daniel Charles Mivelle, Los Angeles, CA (US); Franco Corral, Los Angeles, CA (US); Jean-Hugues Tuan Huy Nguyen, Los Angeles, CA (US)

(21) Appl. No.: 18/069,492

(22) Filed: Dec. 21, 2022

(51) Int. Cl. B62D 33/08; B62D 29/04; B62D 33/02

(52) U.S. Cl. CPC B62D 33/08; B62D 29/043; B62D 33/02

(57) ABSTRACT

A vehicle includes a cab portion, a cargo portion, and a panel arranged separating the cab portion from the cargo portion and extending vertically from a floor of the vehicle. The panel is configured to move in a longitudinal direction of the vehicle to vary a size of the cargo portion. The panel includes a first portion extending vertically upwardly from the floor towards a roof and defining a gap therebetween, and a second portion configured to selectively cover the gap and adapted to be arranged at a first position and a second position. In the first position, the second portion extends vertically from the first portion to cover the gap, and in the second position, the second portion is arranged away from the gap.

### BACKGROUND

The disclosed subject matter relates generally to a vehicle. More particularly, the disclosed subject matter relates a vehicle having an adjustable cargo space.

Pickup truck cargo areas, specifically the pickup truck bed, provide a convenient and utilitarian means of transporting cargo load. However, sizes of the cargo load that can be transported in the pickup truck are generally limited by the size of the cargo area of the pickup truck. Moreover, sometimes, when the pickup truck is utilized to transport a large cargo load, a portion of the cargo load may extend outwardly of rear end of the pickup truck, which is undesirable.

### SUMMARY

In accordance with one embodiment of the present disclosure, a vehicle is provided. The vehicle includes a cab portion, a cargo portion; and a panel arranged separating the cab portion from the cargo portion and extending vertically from a floor of the vehicle. The panel is configured to move in a longitudinal direction of the vehicle to vary a size of the cargo portion. The panel includes a first portion extending vertically upwardly from the floor towards a roof and defining a gap therebetween, and a second portion configured to selectively cover the gap and adapted to be arranged in a first position and a second position. In the first position, the second portion extends vertically from the first portion to cover the gap, and in the second position, the second portion is arranged away from the gap.

In accordance with another embodiment of the present disclosure, a pickup truck is provided. The pickup truck includes a passenger compartment, a loading area, and a panel arranged separating the passenger compartment from the loading area and extending vertically from a floor of the pickup truck. The panel is configured to move in a longitudinal direction of the pickup truck to vary a size of the loading area. The panel includes a first portion extending vertically upwardly from the floor towards a roof and defining a gap therebetween, and a second portion configured to selectively cover the gap and adapted to be arranged in a first position and a second position. In the first position, the second portion extends vertically from the first portion to the roof to cover the gap. In the second position, the second portion is arranged away from the gap.

In accordance with yet a further embodiment of the present disclosure a vehicle is disclosed. The vehicle includes a cab portion, a cargo portion, and a panel arranged separating the cab portion from the cargo portion and extending vertically from a floor of the vehicle. The panel is configured to move in a longitudinal direction of the vehicle to vary a size of the cargo portion. The panel includes a first portion extending vertically upwardly from the floor towards a roof and defining a gap therebetween, and a second portion retractably coupled to the first portion and adapted to move between an extended position and a retracted position. In the extended position, the second portion is arranged covering the gap. In the retracted position, the second portion is arranged away from the gap providing an access of the cargo portion through the cab portion.

### BRIEF DESCRIPTION OF THE DRAWINGS

Certain embodiments of the present disclosure will be better understood from the following description taken in conjunction with the accompanying drawings in which:

FIG. 1 is a rear perspective view of a vehicle having a panel separating a cab portion and a cargo portion and arranged at a forward position with a second portion of the panel disposed at a second position, in accordance with one embodiment of the present disclosure;

FIG. 2 is a rear perspective view of the vehicle having the panel separating the cab portion and the cargo portion and arranged at the forward position with the second portion of the panel being disposed at a first position, in accordance with one embodiment of the present disclosure;

FIG. 3 is a rear perspective view of the vehicle depicting the panel arranged at a rearward position with the second portion of the panel disposed at the second position, in accordance with one embodiment of the present disclosure; and

FIG. 4 is a rear perspective view of the vehicle depicting the panel arranged at the rearward position with the second portion of the panel disposed at the first position, in accordance with one embodiment of the present disclosure.

### DETAILED DESCRIPTION OF EXEMPLARY EMBODIMENTS

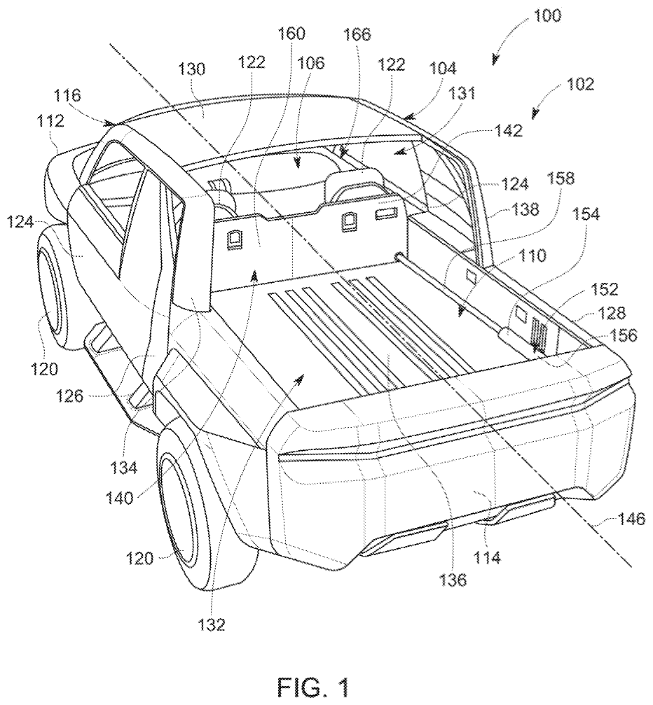

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-4, wherein like numbers indicate the same or corresponding elements throughout the views.

FIGS. 1 to 4 illustrates a rear perspective view of a vehicle 100, in accordance with one embodiment of the disclosure. The vehicle 100 is shown as a pick-up truck 102 having a cab portion 104 defining a passenger compartment 106 and a cargo portion 110 defining a loading area to accommodate a cargo/load for transportation from one location to another location. Although the vehicle 100 is shown and contemplated as the pick-up truck 102, it may be envisioned that the any other vehicle suitable to transport cargo may also be used.

As shown, the vehicle 100 includes a front end 112, a rear end 114 and a vehicle body 116 extending from the front end 112 to the rear end 114. As shown, the vehicle body 116 includes the cab portion 104 extending from the front end 112 towards the rear end 114, and the cargo portion 110 extending from the cab portion 104 to the rear end 114. The vehicle 100 also includes a plurality of traction members, for example wheels 120, supporting the vehicle body 116 on a surface and facilitate a movement of the vehicle 100 over the surface. Further, the vehicle 100 includes an engine module (not shown) having an engine and a transmission assembly operatively connected to the engine and adapted to transmit power from the engine to the wheels 120, of the vehicle 100. In an embodiment, the engine may be an internal combustion engine or an electric motor, of any suitable size and configuration for providing a motive power to the vehicle 100. In one embodiment, the engine module may be arranged at a front portion of the vehicle 100.

As shown in FIGS. 1 to 4, the cab portion 104 defines the passenger compartment 106 of the vehicle 100 and includes a plurality of seats 122 for facilitating a sitting of a passenger and a driver of the vehicle 100. The cab portion 104 includes one or more doors 124 arranged on longitudinal sides 126, 128 of the vehicle 100 to facilitate an access of the passage compartment 106 from outside the vehicle 100. Additionally, the cab portion 104 includes a roof structure 130 covering at least a portion of the passenger compartment 106 from top. Moreover, the cab portion 104 includes an access opening 131 arranged at a rear end of the cab portion 104 to provide access of the cab portion 104 through the cargo portion 110 and vice-versa.

As shown, the cargo portion 110 defines a storage space 132 that is open from top to enable a storage and loading of the cargo inside the vehicle 100. Although, the cargo portion 110 having open top is contemplated, it may be appreciated that the storage space 132 may be an enclosed space that is covered from the top. Further, the vehicle 100 may include a first pillar 134 extending vertically upwardly from a floor 136 of the vehicle 100 and arranged between the roof structure 130 and the rear end 114 of the vehicle 100 in the longitudinal direction of the vehicle 100. Similarly, the vehicle 100 may include a second pillar 138 vertically upwardly from the floor 136 and arranged between the roof structure 130 and the rear end 114 of the vehicle 100 in the longitudinal direction of the vehicle 100. The pillars 134, 138 are arranged on opposing longitudinal sides 126, 128 of the vehicle 100 and are disposed substantially parallel to each other.

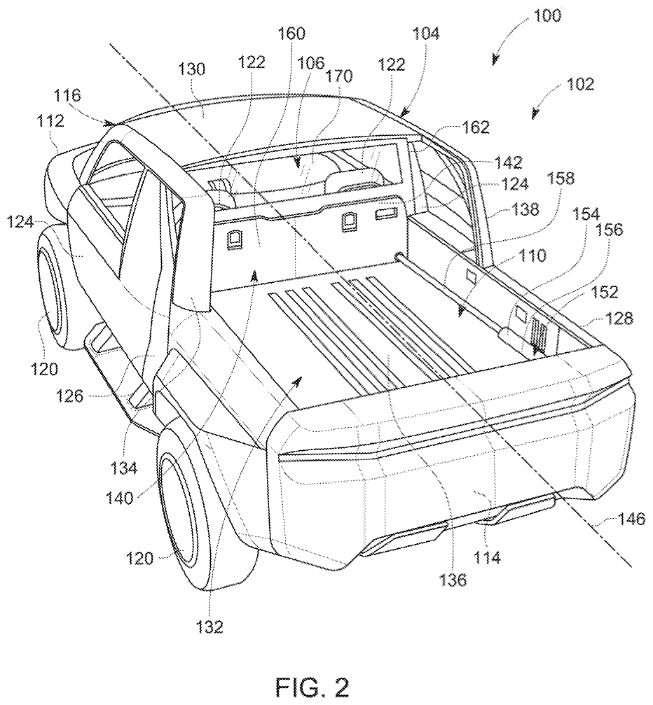

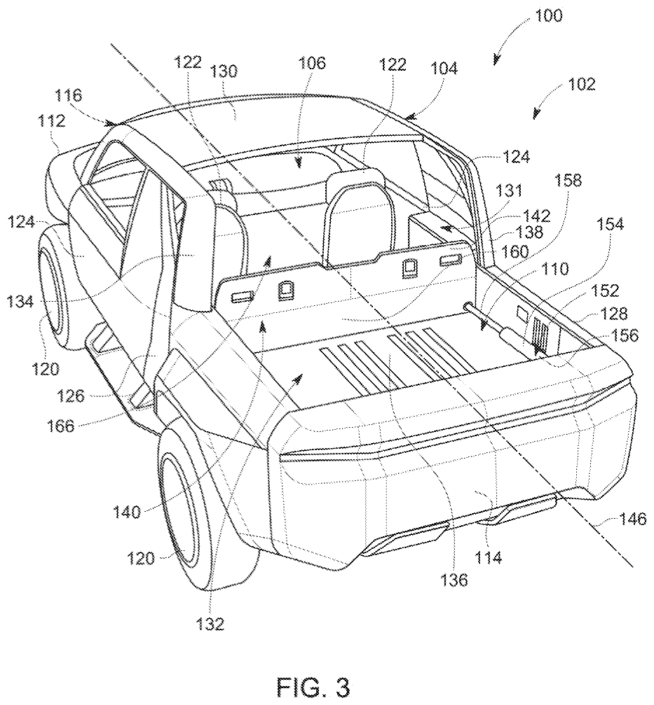

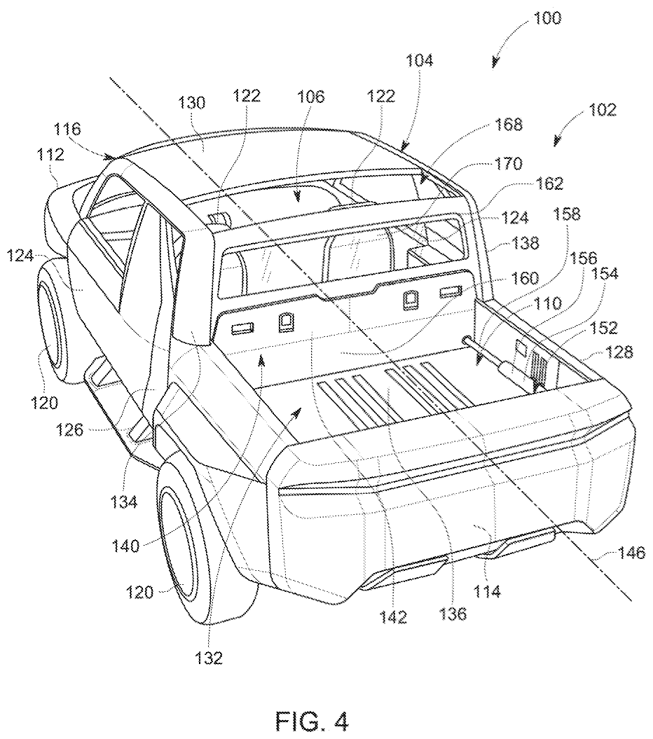

Moreover, the vehicle 100 includes a panel 140 defining a partition wall 142 between the cab portion 104 and the cargo portion 110, separating the cab portion 104 from the cargo portion 110. As shown in FIGS. 1 to 4, the panel 140 extends substantially parallel to lateral sides of the vehicle 100 and is disposed between the first longitudinal side 126 and the second longitudinal side 128. As shown, the panel 140 extends vertically upwardly from the floor 136 the vehicle 100 and is adapted to move between a forward position (shown in FIGS. 1 and 2) and a rearward position (shown in FIGS. 3 and 4) in direction substantially parallel to a longitudinal axis 146 of the vehicle 100 to vary the storage space 132 of the cargo portion 110. Accordingly, by moving the panel 140 in the longitudinal direction, a length of the cargo portion 110 may be varied. As shown in FIGS. 1 and 2, in the forward position, the panel 140 is arranged proximate to the seats 122, while in the rearward position, the panel 140 is arranged relatively distally from the first seats, as shown in FIGS. 3 and 4. In the illustrated embodiment, the panel 140 extends from the first pillar 134 to the second pillar 138, as shown in FIGS. 3 and 4, and may be disposed contacting the pillars 134, 138.

Therefore, in the forward position, a size of the cargo portion 110 is largest, while in the rearward position, the size of the cargo portion 110 is smallest. To move the panel 140 between the forward position and the rearward position, the vehicle 100 may include at least one actuator 152, for example, a linear actuator, to linearly move the panel 140 in the longitudinal direction. In some embodiments, as shown in FIGS. 1 to 4, the actuator 152 may be a cylinder 154 having a cylindrical housing 156 having a first end connected to the vehicle body 116, and a piston 158 adapted to telescopically extend or retract relative to the cylindrical housing 156. In some embodiments, the cylinder 154 may be a hydraulic or a pneumatic cylinder. In some embodiments, the actuator 152 may be a screw type electric actuator. In some embodiments, the actuator 152 may include a rack and pinion arrangement. It may be envisioned that the scope of the present disclosure is not limited by the type of linear actuator, any linear actuator suitable to move the panel 140 in the longitudinal direction is possible. In some embodiments, the actuator 152 may be omitted, and the panel 140 may be moved/slid manually in the longitudinal direction. In such a case, in some embodiments, the vehicle 100 may include a pair of rails to facilitate the sliding of the panel 140.

Further, the panel 140 includes a first portion 160 and a second portion 162 coupled to the first portion 160. As shown, the first portion 160 extends vertically upwardly from the floor 136 towards the roof structure 130 and defines a gap 166 therebetween, while the second portion 162 is coupled to the first portion 160 and is adapted to be move/displaced between a first position (shown in FIG. 2 and FIG. 4) and a second position (shown in FIG. 1 and FIG. 3). In the first position, the second portion 162 is arranged covering the gap 166, while in the second position, the second portion 162 is arranged away from the gap 166 providing an access of the cargo portion 110 through the cab portion 104. The second portion 162 is configured to be moved/displaced between the first position and the second position irrespective of the position of the panel 140 along the longitudinal axis 146 of the vehicle 100. As shown in FIG. 2, when the panel 140 is arranged in the forward position, the second portion 162, in the first position, abuts the roof structure 130 of the passenger compartment 106. Similarly, the second portion 162, in the first position, extends proximate to the upper ends of the pillars 134, 138 when the panel 140 is arranged in the rearward position, as shown in FIG. 4. In such a case, a horizontal space 168 may be defined between the panel 140 and a rear end of the roof structure 130. In some embodiments, the roof structure 130 may include a telescopic portion that can extend and retract to selectively cover the space 168.

In an embodiment, the second portion 162 is adapted to telescopically extend and retract relative to the first portion 160 between an extended position and a retracted position. Accordingly, the extended position corresponds to first position of the second portion 162 in which the second portion 162 extends outwardly, in a telescopic manner, of the first portion 160, and the retracted position corresponds to the second position in which the second portion 162 is arranged retracted inside the first portion 160. Therefore, the second portion 162 is retractably coupled to the first portion 160.

In some embodiments, the second portion 162 is retraced to the retracted position or the second position by rolling the second portion 162 on itself in a roller configuration. In some embodiments, the second portion 162 may be retracted and extended relative to the first portion 160 manually. For example, the second portion 162 is inserted inside the first portion 160 or rolled into the roller configuration by a user manually. In such a case, the second portion 162 is extended to the first position or extended position to cover the gap 166 by manually extending or unrolling the second portion 162.

In some scenarios, the vehicle 100 may include an actuator (not shown) to move the second portion 162 between the first position and the second position. For example, the vehicle 100 or the panel 140 may include a cylinder that may be operated electrically, hydraulically, or pneumatically to extend or retract the second portion 162 relative to the first portion 160. In some embodiments, the second portion 162 is removably coupled to the first portion 160. In such a case, the second portion 162 is moved/displaced to the second position by separating the second portion 162 from the first portion 160. To enable such a configuration, the second portion 162 may be removably engaged with the first portion 160 by using a suitable mechanism, such as, but not limited to, fasteners, clips, hooks, etc. In some embodiments, the panel 140 is made of a weatherproof fabric. In some embodiments, the weatherproof fabric may be a synthetic fabric. The second portion 162 may be removably coupled to the first portion 160 by using zippers, buttons, hooks, etc., when the panel 140 is made of fabric. Further, the second portion 162 may include a transparent structure 170 to enable a viewing of the cargo portion 110 from the cab portion 104 when the second portion 162 is arranged in the first position or extended position. In an embodiment, the second portion 162 may include a window pane that defines the transparent structure 170. In some embodiments, the second portion 162 may be made of transparent plastic defining the transparent structure 170. Although the second portion 162 having the transparent structure 170 is contemplated, it may be appreciated that the second portion 162 may be made of any translucent or opaque material known in the art.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A vehicle, comprising:
a cab portion;
a cargo portion; and
a panel arranged separating the cab portion from the cargo portion and extending vertically from a floor of the vehicle, the panel is configured to move in a longitudinal direction of the vehicle to vary a size of the cargo portion, the panel including
a first portion extending vertically upwardly from the floor towards a roof and defining a gap therebetween, and
a second portion configured to selectively cover the gap and adapted to be arranged at a first position and a second position, wherein
in the first position, the second portion extends vertically from the first portion to cover the gap, and
in the second position, the second portion is arranged away from the gap.

2. The vehicle of claim 1, wherein the second portion is removably coupled to the first portion, wherein in the second position, the second portion is disposed separated from the first portion.

3. The vehicle of claim 1, wherein the second portion is retractably coupled to the first portion, wherein the second portion is retracted to move the second portion in the second position.

4. The vehicle of claim 3, wherein the second portion is telescopically retractable relative to the first portion.

5. The vehicle of claim 3, wherein the second portion is retracted by folding the second portion in a roller configuration.

6. The vehicle of claim 1, wherein the second portion includes a transparent structure to enable a viewing of the cargo portion from the cab portion.

7. The vehicle of claim 1, wherein the panel is made of a synthetic weatherproof material.

8. The vehicle of claim 1, wherein the panel is configured to move between a first position and a second position in the longitudinal direction, wherein a length of the cargo portion is decreased in response to the movement of the panel from the first position to the second position.

9. The vehicle of claim 1 further including at least one actuator to move the panel in the longitudinal direction.

10. A pickup truck, comprising:
a passenger compartment;
a loading area; and
a panel arranged separating the passenger compartment from the loading area and extending vertically from a floor of the pickup truck, the panel is configured to move in a longitudinal direction of the pickup truck to vary a size of the loading area, the panel including
a first portion extending vertically upwardly from the floor towards a roof and defining a gap therebetween, and
a second portion configured to selectively cover the gap and adapted to be arranged at a first position and a second position, wherein
in the first position, the second portion extends vertically from the first portion to the roof to cover the gap, and
in the second position, the second portion is arranged away from the gap.

11. The pickup truck of claim 10, wherein the second portion is removably coupled to the first portion, wherein in the second position, the second portion is arranged separated from the first portion.

12. The pickup truck of claim 10, wherein the second portion is retractably coupled to the first portion, wherein the second portion is retracted relative to the first portion to move the second portion in the second position.

13. The pickup truck of claim 12, wherein the second portion is telescopically retractable relative to the first portion.

14. The pickup truck of claim 12, wherein the second portion is retracted by folding the second portion in a roller configuration.

15. The pickup truck of claim 10, wherein the second portion includes a transparent structure to enable a viewing of the loading area from the passenger compartment.

16. The pickup truck of claim 10, wherein the panel is made of a synthetic weatherproof material.

17. The pickup truck of claim 10, wherein the panel is configured to move between a first position and a second position in the longitudinal direction, wherein a length of the loading area is decreased in response to the movement of the panel from the first position to the second position.

18. The pickup truck of claim 10 further including at least one actuator to move the panel in the longitudinal direction.

19. A vehicle, comprising:
a cab portion;
a cargo portion; and
a panel arranged separating the cab portion from the cargo portion and extending vertically from a floor of the vehicle, the panel is configured to move in a longitudinal direction of the vehicle to vary a size of the cargo portion, the panel including
a first portion extending vertically upwardly from the floor towards a roof and defining a gap therebetween, and
a second portion retractably coupled to the first portion and adapted to move between an extended position and a retracted position, wherein
in the extended position, the second portion is arranged covering the gap, and
in the retracted position, the second portion is arranged away from the gap providing an access of the cargo portion through the cab portion.

20. The vehicle of claim 19, wherein the second portion includes a transparent structure to enable a viewing of the cargo portion from the cab portion.
